(19) United States
(12) Patent Application Publication
(10) Pub. No.: US 2022/0130054 A1
(43) Pub. Date: Apr. 28, 2022

(54) POSITION FINDING METHOD AND POSITION FINDING SYSTEM

(71) Applicant: TOYOTA JIDOSHA KABUSHIKI KAISHA, Aichi-ken (JP)

(72) Inventors: Takahiro OKANO, Chiryu-shi (JP); Takaaki YANAGIHASHI, Toyota-shi (JP); Hiroaki KIYOKAMI, Nisshin-shi (JP); Toru TAKASHIMA, Susono-shi (JP); Kenta MIYAHARA, Okazaki-shi (JP); Yohei TANIGAWA, Toyota-shi (JP)

(21) Appl. No.: 17/503,365

(22) Filed: Oct. 18, 2021

(30) Foreign Application Priority Data
Oct. 23, 2020 (JP) 2020-178398

(51) Int. Cl. G06T 7/246; B60R 11/04; H04N 5/225

(52) U.S. Cl. CPC G06T 7/246; B60R 11/04; B60R 2300/10; G06T 2207/30252; B60R 2300/303; H04N 5/2257

(57) ABSTRACT

A position finding method including capturing respective images of multiple locations on a movement route of a moving body at the multiple locations, associating the respective images of the multiple locations with respective position information relating to the multiple locations, storing the respective images on a storage medium in association with the respective position information, capturing an image of a current position of the moving body from the moving body while the moving body is moving along the movement route, performing image matching between the current position image and the respective images stored on the storage medium, and finding the current position of the moving body based on a result of the image matching.

### CROSS-REFERENCE TO RELATED APPLICATION

This application is based on and claims priority under 35 USC 119 from Japanese Patent Application No. 2020-178398 filed on Oct. 23, 2020, the disclosure of which is incorporated by reference herein.

### BACKGROUND

### Technical Field

The present disclosure relates to a position finding method and a position finding system for finding a current position of a moving body.

### Related Art

Japanese Patent Application Laid-Open (JP-A) No. 2010-282393 discloses a moving device that moves independently inside a factory or the like. The moving device includes a storage section stored with map information including positions of guide markings provided on a floor, and a control section including a captured image analysis section that applies processing to captured images captured by a camera. The moving device matches captured images of the guide markings against respective positions in the map information, and moves while ascertaining its own position in an action region included in the map information.

### SUMMARY

In the above-described related art, since guide markings need to be provided on the floor, locations suitable for application of this technology are limited. There is accordingly room for improvement from the perspective of enabling a wider range of application.

In consideration of the above circumstances, the present disclosure obtains a position finding method and a position finding system capable of a wider range of application.

A first aspect of the present disclosure is a position finding method including capturing respective images of multiple locations on a movement route of a moving body at the multiple locations, associating the respective images of the multiple locations with respective position information relating to the multiple locations, storing the respective images on a storage medium in association with the respective position information, capturing an image of a current position of the moving body from the moving body while the moving body is moving along the movement route, performing image matching between the current position image and the respective images stored on the storage medium to identify a single image that is a match for the current position image from among the respective images, and finding the current position of the moving body based on position information associated with the single image.

In the position finding method of the first aspect, image capture is performed at the multiple locations on the movement route of the moving body. The respective captured images of the multiple locations are stored on the storage medium in association with the position information relating to the multiple locations. An image of the current position of the moving body is captured from the moving body while the moving body is moving along the movement route. Image matching is performed between the current position image and the respective images of the multiple locations stored on the storage medium to identify a single image that is a match for the current position image from among the respective images. The current position of the moving body is then found based on position information associated with the single image thus identified. Since this position finding method obviates the need to provide guide markings on a floor, a wider range of application is possible than when employing methods in which such guide markings are used to find the position. Note that, for example, the reference to “multiple locations” in the first aspect refers to ten or more locations.

A position finding method of a second aspect of the present disclosure is the first aspect, wherein the movement route is an indoor movement route provided indoors, the indoor movement route is connected to an outdoor movement route provided outdoors, and while the moving body is moving along the outdoor movement route, the current position of the moving body is found using a GPS device installed to the moving body.

In the position finding method of the second aspect, while the moving body is moving along the indoor movement route, the current position of the moving body is found based on a result of the image matching described above. While the moving body is moving along the outdoor movement route, the current position of the moving body is found using the Global Positioning System (GPS) device installed to the moving body. While indoors, it is difficult to receive signals from GPS satellites. However, since there is less variation in the appearance of the surroundings as a result of the weather or the time of day, precise image matching is more easily secured. It is therefore preferable to switch the method employed to find the current position in the manner described above.

A position finding method of a third aspect of the present disclosure is the first aspect, wherein the moving body is a walking robot.

In the position finding method of the third aspect, the current position of the walking robot is found based on the result of the image matching described above while the walking robot is moving along the movement route. Since the walking robot moves at a lower speed than a typical vehicle, there is ample time in which to perform the image matching processing.

A position finding method of a fourth aspect of the present disclosure is the first aspect, wherein identifiers are respectively allocated to the multiple locations, and the respective images are stored on the storage medium so as to be associated with the respective position information using the respective identifiers.

In the position finding method of the fourth aspect, the respective identifiers (for example numbers, symbols, or names) are allocated to the multiple locations on the movement route of the moving body. The respective identifiers are used to associate the respective images of the multiple locations with the respective position information. Employing such identifiers facilitates association of the respective images with the respective position information.

A position finding system of a fifth aspect of the present disclosure includes a storage section configured to store on a storage medium respective images of multiple locations on a movement route of a moving body and captured at the multiple locations such that the respective images are in association with respective position information relating to the multiple locations, an in-motion imaging section installed to the moving body and configured to capture an image of a current position of the moving body while the moving body is moving along the movement route, a matching section configured to perform image matching between the current position image and the respective images stored on the storage medium to identify a single image that is a match for the current position image from among the respective images, and a position finding section configured to find the current position of the moving body from the position information associated with the single image.

In the position finding system of the fifth aspect, the storage section stores on the storage medium the respective images captured at the multiple locations on the movement route of the moving body such that the respective images of the multiple locations are in association with the respective position information relating to the multiple locations. The in-motion imaging section is installed to the moving body and captures an image of the current position of the moving body from the moving body while the moving body is moving along the movement route. The matching section performs image matching between the current position image and the respective images of the multiple locations stored on the storage medium of the storage section to identify a single image that is a match for the current position image from among the respective images. The position finding section finds the current position of the moving body based on position information associated with the single image. Since this position finding system obviates the need to provide guide markings on a floor, a wider range of application is possible than when employing configurations in which a position is found using such guide markings.

A position finding system of a sixth aspect of the present disclosure is the fifth aspect, wherein the movement route is an indoor movement route provided indoors, the indoor movement route is connected to an outdoor movement route provided outdoors, and while the moving body is moving along the outdoor movement route, the current position of the moving body is found using a GPS device installed to the moving body.

In the position finding system of the sixth aspect, while the moving body is moving along the indoor movement route, the position finding section finds the current position of the moving body based on a result of the image matching described above. While the moving body is moving along the outdoor movement route, the current position of the moving body is found using the GPS device installed to the moving body. While indoors, it is difficult to receive signals from GPS satellites. However, since there is less variation in the appearance of the surroundings as a result of the weather or the time of day, precise image matching is more easily secured. It is therefore preferable to switch the method employed to find the current position in the manner described above.

A position finding system of a seventh aspect of the present disclosure is the fifth aspect, wherein the moving body is a walking robot.

In the position finding system of the seventh aspect, the current position of the walking robot is found based on the result of the image matching described above while the walking robot is moving along the movement route. Since the walking robot moves at a lower speed than a typical vehicle, there is ample time in which to perform the image matching processing.

A position finding system of an eighth aspect of the present disclosure is the fifth aspect, wherein the storage section is configured to store the respective images on the storage medium so as to be associated with the respective position information using identifiers respectively allocated to the multiple locations.

In the position finding system of the eighth aspect, the storage section stores the respective images of the multiple locations on the storage medium such that the respective identifiers (for example numbers, symbols, or names) allocated to the multiple locations on the movement route of the moving body are used to associate the respective images with the respective position information regarding the multiple locations. Employing such identifiers facilitates association of the respective images with the respective position information.

As described above, the position finding method and the position finding system according to the present disclosure enable a wider range of application.

### BRIEF DESCRIPTION OF THE DRAWINGS

Exemplary embodiments of the present disclosure will be described in detail based on the following figures, wherein:

FIG. 1 is an outline view illustrating a schematic configuration of a position finding system according to an exemplary embodiment of the present disclosure;

FIG. 2 is a block diagram illustrating a hardware configuration of a component transporter vehicle according to the present exemplary embodiment;

FIG. 3 is a block diagram illustrating relevant functional configuration of a navigation device installed to a component transporter vehicle;

FIG. 4 is a block diagram illustrating a hardware configuration of a walking robot according to the present exemplary embodiment;

FIG. 5 is a block diagram illustrating relevant functional configuration of a robot control device installed to a walking robot;

FIG. 6 is a block diagram illustrating a hardware configuration of a pre-imaging vehicle according to the present exemplary embodiment;

FIG. 7 is a block diagram illustrating relevant functional configuration of a pre-imaging device installed to a pre-imaging vehicle;

FIG. 8 is a block diagram illustrating a hardware configuration of a control center according to the present exemplary embodiment;

FIG. 9 is a block diagram illustrating relevant functional configuration of a position finding device provided at a control center;

FIG. 10 is a plan view cross-section illustrating movement routes of a moving body of the present exemplary embodiment;

FIG. 11 is a diagram illustrating an example of an image of an indoor movement route as captured from a moving body; and

FIG. 12 is a flowchart illustrating an example of a flow of control processing implemented by a position finding device.

### DETAILED DESCRIPTION

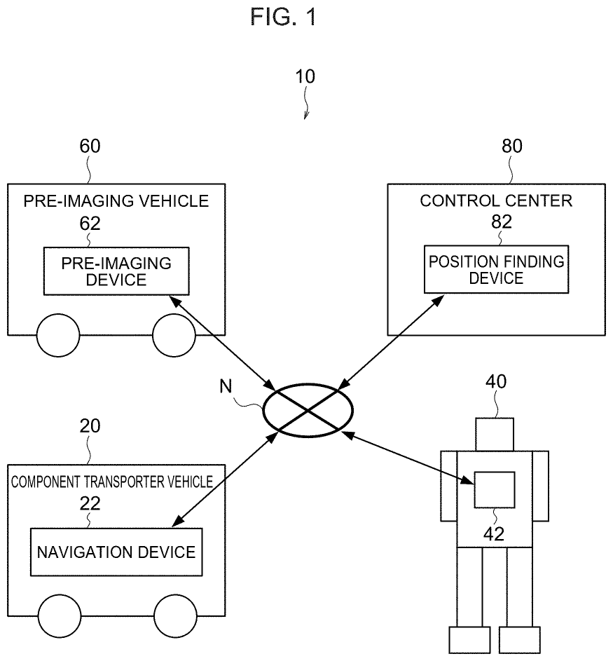

Explanation follows regarding a position finding method and a position finding system 10 according to an exemplary embodiment of the present disclosure, with reference to FIG. 1 to FIG. 12. As an example, the position finding method according to the present exemplary embodiment is a method for finding the position of a moving body moving on the site of a factory (hereafter simply referred to as “inside the factory”). The method is implemented by the position finding system 10 according to the present exemplary embodiment. As an example, the position finding system 10 is configured by a component transporter vehicle 20, a walking robot 40, a pre-imaging vehicle 60, and a control center 80.

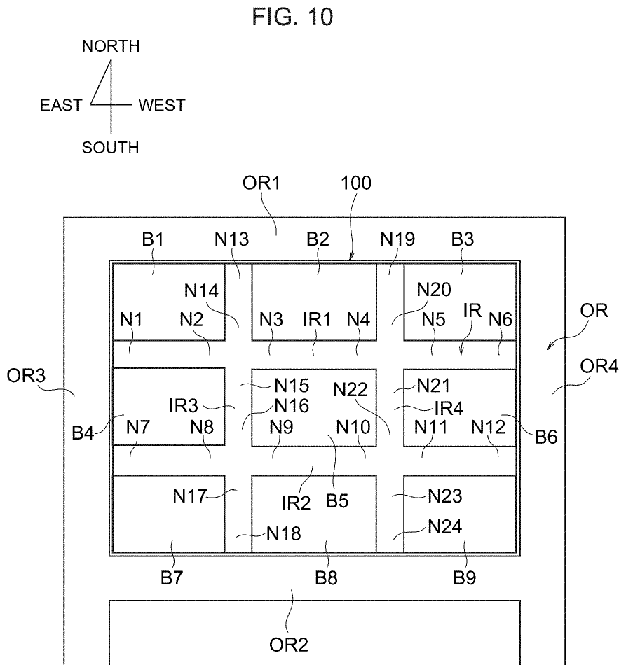

The component transporter vehicle 20 and the walking robot 40 each correspond to a “moving body” of the present disclosure. The component transporter vehicle 20 is an example of a vehicle that travels around inside the factory, and is employed to transport components inside the factory. The walking robot 40 is an example of a robot used for in-factory management and so on, and is capable of walking on two legs. The pre-imaging vehicle 60 is a vehicle employed to comprehensively image movement routes of moving bodies, including the component transporter vehicle 20 and the walking robot 40, inside a factory building (see the building 100 illustrated in FIG. 10). The control center 80 is a center for managing movement of the moving bodies inside the factory, and is provided inside the factory.

A navigation device 22 is installed to the component transporter vehicle 20. A robot control device 42 is installed to the walking robot 40. A pre-imaging device 62 is installed to the pre-imaging vehicle 60. A position finding device 82 is provided at the control center 80. The pre-imaging device 62, the navigation device 22, the robot control device 42, and the position finding device 82 are connected so as to be capable of communicating with each other over a network N. The network N may, for example, be a wireless communication network or a wired communication network employing public lines, such as the internet.

Configuration of Component Transporter Vehicle

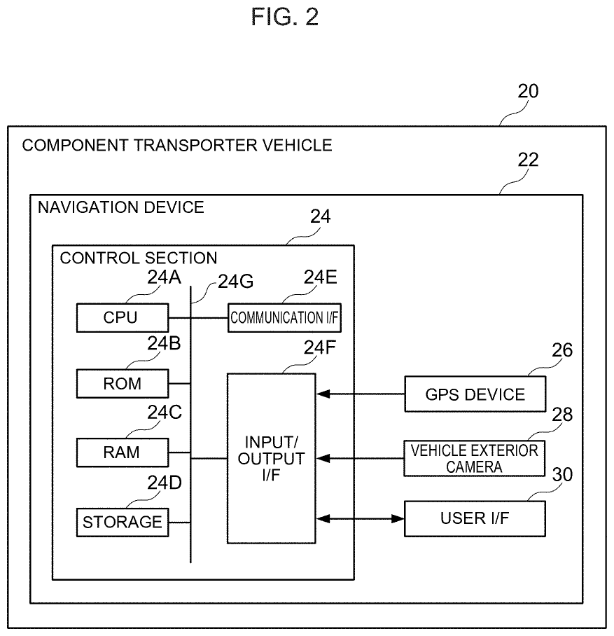

As an example, the component transporter vehicle 20 is configured by a manually driven vehicle. FIG. 2 is a block diagram illustrating a hardware configuration of the navigation device 22 installed to the component transporter vehicle 20. The navigation device 22 includes a control section 24, a global positioning system (GPS) device 26, a vehicle exterior camera 28, and a user interface (I/F) 30.

The control section 24 is configured including a central processing unit (CPU; a processor) 24A, read only memory (ROM) 24B, random access memory (RAM) 24C, storage 24D, a communication I/F 24E, and an input/output I/F 24F. The CPU 24A, the ROM 24B, the RAM 24C, the storage 24D, the communication I/F 24E, and the input/output I/F 24F are connected so as to be capable of communicating with each other through a bus 24G.

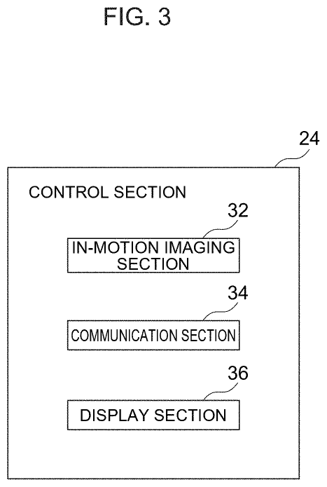

The CPU 24A is a central processing unit that executes various programs and controls various sections. Namely, the CPU 24A reads a program from the ROM 24B and executes the program using the RAM 24C as a workspace. In the present exemplary embodiment, a program is stored in the ROM 24B. When the CPU 24A executes this program, the control section 24 of the navigation device 22 functions as an in-motion imaging section 32, a communication section 34, and a display section 36, illustrated in FIG. 3.

The ROM 24B stores various programs and various data. The RAM 24C acts as a workspace to temporarily store a program or data. The storage 24D is configured by a hard disk drive (HDD) or a solid state drive (SSD), and stores various programs including an operating system, a map database, and the like. The communication I/F 24E includes an interface for connecting to the network N in order to communicate with the position finding device 82 of the control center 80. A communication protocol such as LTE or Wi-Fi (registered trademark) may be employed for this interface.

The input/output I/F 24F is an interface for communicating with various devices installed to the component transporter vehicle 20. The GPS device 26, the vehicle exterior camera 28, and the user I/F 30 are connected to the navigation device 22 of the present exemplary embodiment through the input/output I/F 24F. Note that alternatively, the GPS device 26, the vehicle exterior camera 28, and the user I/F 30 may be directly connected to the bus 24G.

The GPS device 26 includes an antenna (not illustrated in the drawings) to receive signals from GPS satellites in order to measure the current position of the component transporter vehicle 20. The vehicle exterior camera 28 is a camera that images the surroundings of the component transporter vehicle 20. As an example, the vehicle exterior camera 28 is a monocular camera that images ahead of the component transporter vehicle 20. Note that alternatively, the vehicle exterior camera 28 may be a stereo camera or a 360-degree camera. The user I/F 30 may include a display configuring a display section, and a speaker configuring an audio output section (neither of which are illustrated in the drawings). Such a display may be configured by a capacitance-type touch panel.

As mentioned above, the navigation device 22 includes the in-motion imaging section 32, the communication section 34, and the display section 36 illustrated in FIG. 3 as functional configuration. This functional configuration is implemented by the CPU 24A reading and executing the program stored in the ROM 24B.

The in-motion imaging section 32 is provided with functionality to implement an “in-motion imaging step” of the present disclosure. Specifically, the in-motion imaging section 32 has a function of imaging ahead of the component transporter vehicle 20 using the vehicle exterior camera 28 in cases in which the GPS device 26 becomes unable to receive signals from GPS satellites, for example due to the component transporter vehicle 20 moving from outside the factory building to inside the factory building. This imaging may be performed at fixed time intervals. An image obtained by this imaging corresponds to an “image of a current position” of the present disclosure. This image of the current position is hereafter referred to as the “current position image”.

The communication section 34 has a function of communicating with the position finding device 82 of the control center 80 over the network N. The communication section 34 transmits data of images captured by the vehicle exterior camera 28 to the position finding device 82, and receives information regarding the current position of the component transporter vehicle 20 from the position finding device 82. The display section 36 has a function of displaying the current position information received by the communication section 34 on the display of the user I/F 30.

Configuration of Walking Robot

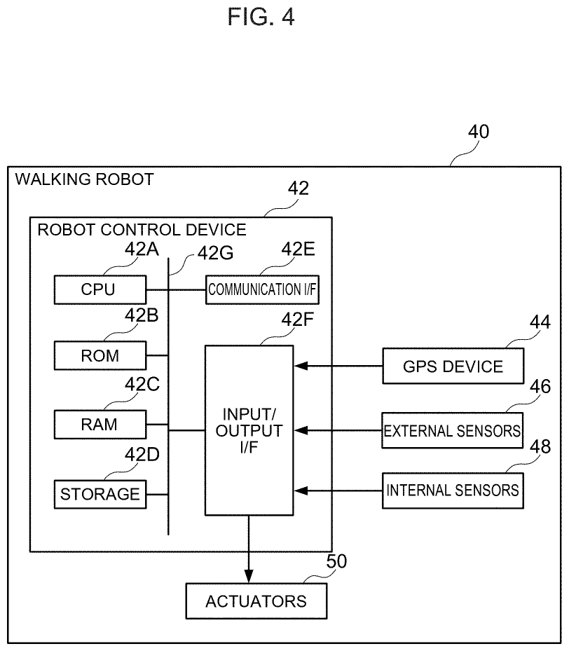

FIG. 4 is a block diagram illustrating a hardware configuration of the walking robot 40. The walking robot 40 includes the robot control device 42, a GPS device 44, external sensors 46, internal sensors 48, and actuators 50.

The robot control device 42 is configured including a CPU 42A, ROM 42B, RAM 42C, storage 42D, a communication I/F 42E, and an input/output I/F 42F. The CPU 42A, the ROM 42B, the RAM 42C, the storage 42D, the communication I/F 42E, and the input/output I/F 42F are connected so as to be capable of communicating with each other through a bus 42G. Functionality of the CPU 42A, the ROM 42B, the RAM 42C, the storage 42D, the communication I/F 42E, and the input/output I/F 42F is the same as the functionality of the CPU 24A, the ROM 24B, the RAM 24C, the storage 24D, the communication I/F 24E, and the input/output I/F 24F of the control section 24 of the component transporter vehicle 20 previously described.

The CPU 42A reads a program from the storage 42D and executes the program using the RAM 42C as a workspace. The robot control device 42 thereby generates an action plan to cause the walking robot 40 to act. A walking plan to cause the walking robot 40 to walk is included in the action plan. The walking plan is generated using a map database and so on stored in the storage 42D. The GPS device 44, the external sensors 46, the internal sensors 48, and the actuators 50 are connected to the input/output I/F 42F of the robot control device 42. Note that alternatively, the GPS device 44, the external sensors 46, the internal sensors 48, and the actuators 50 may be directly connected to the bus 42G.

Functionality of the GPS device 44 is the same as that of the GPS device 26 of the component transporter vehicle 20, and the GPS device 44 uses signals from GPS satellites to measure the current position of the walking robot 40. The external sensors 46 are a set of sensors used to detect surroundings information regarding the surroundings of the walking robot 40. The external sensors 46 include a camera (not illustrated in the drawings) for imaging the surroundings of the walking robot 40. The camera includes at least one camera out of a monocular camera, a stereo camera, or a 360-degree camera. Note that the external sensors 46 may include a millimeter-wave radar unit that transmits search waves over a predetermined range in the surroundings of the walking robot 40 and receives reflected waves, a laser imaging detection and ranging (LIDAR) unit that scans the predetermined range, or the like. The internal sensors 48 are a set of sensors that detect states of respective sections of the walking robot 40. The actuators 50 include plural electrical actuators that drive various sections of the walking robot 40.

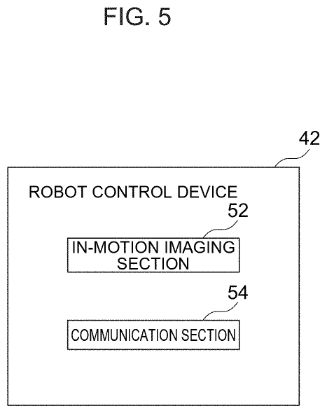

FIG. 5 is a block diagram illustrating relevant functional configuration of the robot control device 42. As illustrated in FIG. 5, the robot control device 42 includes an in-motion imaging section 52 and a communication section 54 as functional configuration. This functional configuration is implemented by the CPU 42A reading and executing a program stored in the ROM 42B.

The in-motion imaging section 52 is provided with functionality to implement the “in-motion imaging step” of the present disclosure. Specifically, the in-motion imaging section 52 has a function of imaging the surroundings of the walking robot 40 using the camera of the external sensors 46 in cases in which the GPS device 44 becomes unable to receive signals from GPS satellites, for example due to the walking robot 40 moving from outside the factory building to inside the factory building. This imaging may be performed at fixed time intervals. An image obtained by this imaging corresponds to an “image of a current position” of the present disclosure. This image of the current position image is hereafter referred to as the “current position image”.

The communication section 54 has a function of communicating with the position finding device 82 of the control center 80 over the network N. The communication section 54 transmits data of images captured by the external sensors 46 to the position finding device 82, and receives information regarding the current position of the walking robot 40 from the position finding device 82.

Configuration of Pre-Imaging Vehicle

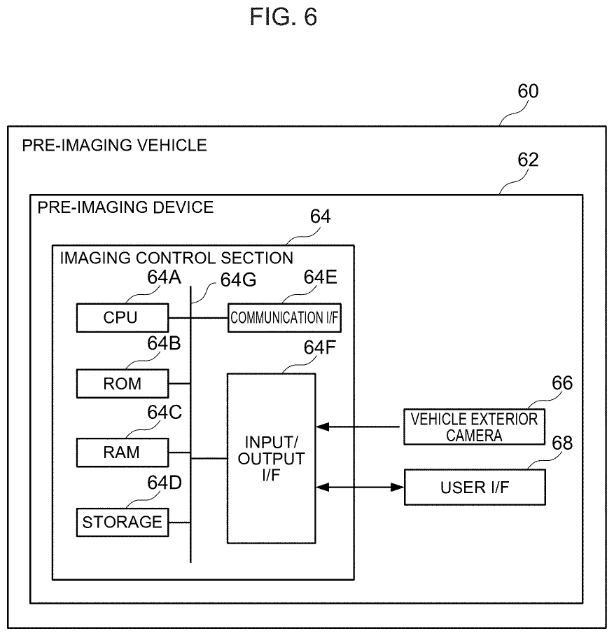

As an example, the pre-imaging vehicle 60 is configured by a manually driven vehicle. FIG. 6 is a block diagram illustrating a hardware configuration of the pre-imaging device 62 installed to the pre-imaging vehicle 60. The pre-imaging device 62 includes an imaging control section 64, a vehicle exterior camera 66, and a user I/F 68.

The imaging control section 64 is configured including a CPU 64A, ROM 64B, RAM 64C, storage 64D, a communication I/F 64E, and an input/output I/F 64F. The CPU 64A, the ROM 64B, the RAM 64C, the storage 64D, the communication I/F 64E, and the input/output I/F 64F are connected so as to be capable of communicating with each other through a bus 64G. Functionality of the CPU 64A, the ROM 64B, the RAM 64C, the storage 64D, the communication I/F 64E, and the input/output I/F 64F is the same as the functionality of the CPU 24A, the ROM 24B, the RAM 24C, the storage 24D, the communication I/F 24E, and the input/output I/F 24F of the control section 24 of the component transporter vehicle 20 previously described.

The CPU 64A reads a program from the storage 64D and executes the program using the RAM 64C as a workspace. The vehicle exterior camera 66 and the user I/F 68 are connected to the input/output I/F 64F. Note that alternatively, the vehicle exterior camera 66 and the user I/F 68 may be directly connected to the bus 64G. As an example, the vehicle exterior camera 66 is a monocular camera that images ahead of the pre-imaging vehicle 60. Note that alternatively, the vehicle exterior camera 66 may be a stereo camera or a 360-degree camera. The user I/F 68 may include a display configuring a display section, and a speaker configuring an audio output section (neither of which are illustrated in the drawings). Such a display may be configured by a capacitance-type touch panel.

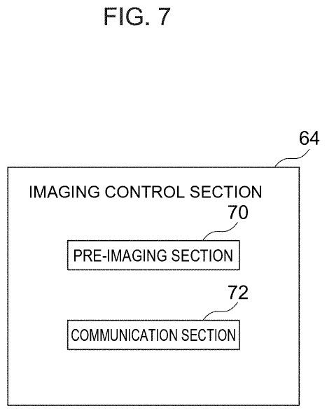

FIG. 7 is a block diagram illustrating relevant functional configuration of the imaging control section 64. As illustrated in FIG. 7, the imaging control section 64 includes a pre-imaging section 70 and a communication section 72 as functional configuration. This functional configuration is implemented by the CPU 64A reading and executing a program stored in the ROM 64B.

The pre-imaging section 70 has a function of capturing respective images of multiple locations using the vehicle exterior camera 66, these multiple locations being on an indoor movement route provided inside the factory building. This imaging may be performed by the pre-imaging section 70 receiving instructions from an occupant of the pre-imaging vehicle 60 through the user I/F 68. This imaging corresponds to implementation of a “pre-imaging step” of the present disclosure. The respective captured images are stored in the storage 64D. The respective images captured during the pre-imaging step are associated (i.e. held in a unique association) with position information regarding each of the multiple locations during an association step. Note that an identifier allocation step is implemented before the association step and the pre-imaging step.

In the identifier allocation step, respective identifiers (such as numbers, symbols, or names) are allocated to the multiple locations on the movement route of the moving bodies. This identifier allocation step may be implemented by an operator at the factory. This identifier information is held in both the map database included in the navigation device 22 of the component transporter vehicle 20, and in the map database included in the robot control device 42 of the walking robot 40.

After the identifier allocation step has been implemented, respective images of the multiple locations are captured by the occupant of the pre-imaging vehicle 60. After capturing the respective images, the occupant of the pre-imaging vehicle 60 may for example allocate identifiers to the respective image data using the user I/F 68. Each piece of the image data that has been allocated a corresponding identifier is stored in the storage 64D. The respective images allocated corresponding identifiers are also referred to hereafter as the “multiple pre-captured images”.

Note that although the identifier allocation step, the pre-imaging step, and the association step are all implemented by an operator at the factory in the present exemplary embodiment, there is no limitation thereto. For example, these steps may be implemented by a walking robot provided with an artificial intelligence. In such cases, the identifier allocation step, the pre-imaging step, and the association step may be implemented simultaneously or substantially simultaneously.

The communication section 72 has a function of communicating with the position finding device 82 of the control center 80 over the network N. The communication section 72 transmits data of the multiple pre-captured images stored in the storage 64D to the position finding device 82.

Configuration of Control Center

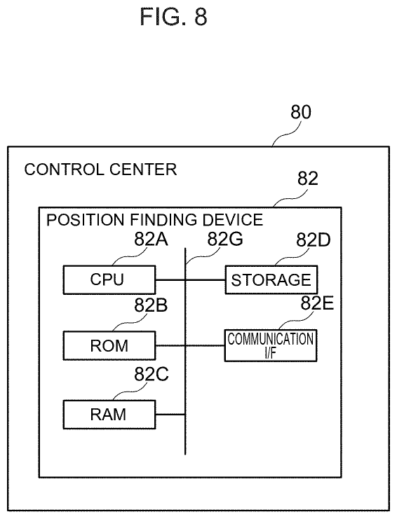

FIG. 8 is a block diagram illustrating a hardware configuration of the position finding device 82 provided at the control center 80. The position finding device 82 is configured including a CPU 82A, ROM 82B, RAM 82C, storage 82D, and a communication I/F 82E. The CPU 82A, the ROM 82B, the RAM 82C, the storage 82D, and the communication I/F 82E are connected so as to be capable of communicating with each other through a bus 82G. Functionality of the CPU 82A, the ROM 82B, the RAM 82C, the storage 82D, and the communication I/F 82E is the same as the functionality of the CPU 24A, the ROM 24B, the RAM 24C, the storage 24D, and the communication I/F 24E of the control section 24 of the component transporter vehicle 20 previously described.

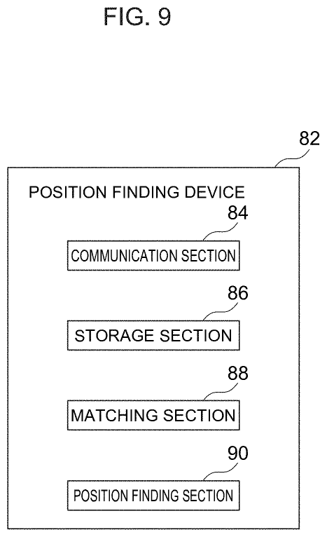

The CPU 82A reads a program from the storage 82D and executes the program using the RAM 82C as a workspace. By executing the program, the position finding device 82 functions as a communication section 84, a storage section 86, a matching section 88, and a position finding section 90, as illustrated in FIG. 9.

The communication section 84 has a function of communicating with the navigation device 22 of the component transporter vehicle 20, the robot control device 42 of the walking robot 40, and the pre-imaging device 62 of the pre-imaging vehicle 60 over the network N. The communication section 84 receives data of the multiple pre-captured images from the pre-imaging device 62, and receives current position image data from both the navigation device 22 and the robot control device 42.

The storage section 86 is provided with functionality to implement a “storage step” of the present disclosure. Specifically, the storage section 86 stores the data of the multiple pre-captured images received from the pre-imaging device 62 by the communication section 84 in the storage 82D. The storage 82D corresponds to a “storage medium” of the present disclosure.

The matching section 88 is provided with functionality to implement a “matching step” of the present disclosure. The matching section 88 performs image matching between a current position image and the multiple pre-captured images. This image matching may take the form of area-based image matching (template matching) or feature-based image matching. Area-based image matching is a technique in which image data is superimposed as-is. In area-based image matching, a pattern corresponding to a target object is expressed as an image (what is referred to as a template image) and this template image is moved around within a search range to identify the location that is most similar. Feature-based image matching is a technique involving superimposition of an image structure, namely levels representing positional relationships between feature points extracted from an image. In feature-based image matching, first, edges and feature points are extracted from an image, and the shapes and spatial positional relationships thereof are expressed as a line drawing. Superimposition is then performed based on similarities in structures between line drawings. The matching section 88 employs image matching such as that described above to identify a single pre-captured image that is a match for the current position image.

The position finding section 90 is provided with functionality to implement a “position finding step” of the present disclosure. The position finding section 90 finds (identifies) the current position of the component transporter vehicle 20 or the walking robot 40 based on results of the image matching implemented by the matching section 88. Specifically, the position finding section 90 finds the current position of the component transporter vehicle 20 or the walking robot 40 using the identifier (i.e. position information) allocated to the single pre-captured image identified by the matching section 88. Having found the current position of the component transporter vehicle 20 or the walking robot 40, the position finding section 90 transmits information regarding the current position thus found to the navigation device 22 or the robot control device 42 through the communication section 84.

Movement Routes of Moving Bodies

FIG. 10 is a plan view cross-section illustrating an example of a factory where the component transporter vehicle 20 and the walking robot 40 are employed. In this example, lattice shaped indoor movement routes IR are provided inside the factory building 100 (i.e. indoors). Outdoor movement routes OR are provided around the exterior of the building 100.

The indoor movement routes IR correspond to “movement routes” of the present disclosure. The indoor movement routes IR are configured by a pair of routes IR1, IR2 that extend from east to west and are arrayed in a north-south direction, and a pair of routes IR3, IR4 that extend from north to south and are arrayed in an east-west direction. The routes IR1 to IR4 include mutual intersections. The routes IR1 to IR4 divide the interior of the building 100 into plural blocks B1 to B9.

The outdoor movement routes OR include a pair of routes OR1, OR2 extending from east to west on the north side and the south side of the building 100 respectively, and a pair of routes OR3, OR 4 extending from north to south on the east side and the west side of the building 100 respectively. The routes OR1, OR2 are connected to the routes IR3, IR4 configuring the indoor movement routes IR, and the routes OR3, OR4 are connected to the routes IR1, IR2 configuring the indoor movement routes IR.

In the present exemplary embodiment, the respective identifiers are allocated to multiple locations on the indoor movement routes IR during the identifier allocation step described previously. In the example illustrated in FIG. 10, identifiers numbered N1 to N24 are allocated to multiple locations on the routes IR1 to IR4 configuring the indoor movement routes IR. Information regarding these numbers N1 to N24 is held in the map databases.

The numbers N1 to N24 are allocated to the respective images of the multiple locations that have been captured in images by for example the occupant of the pre-imaging vehicle 60 as previously described. The respective images allocated with the numbers N1 to N24 are transmitted to the position finding device 82 of the control center 80 as the multiple pre-captured images, and are stored in the storage section 86 of the position finding device 82.

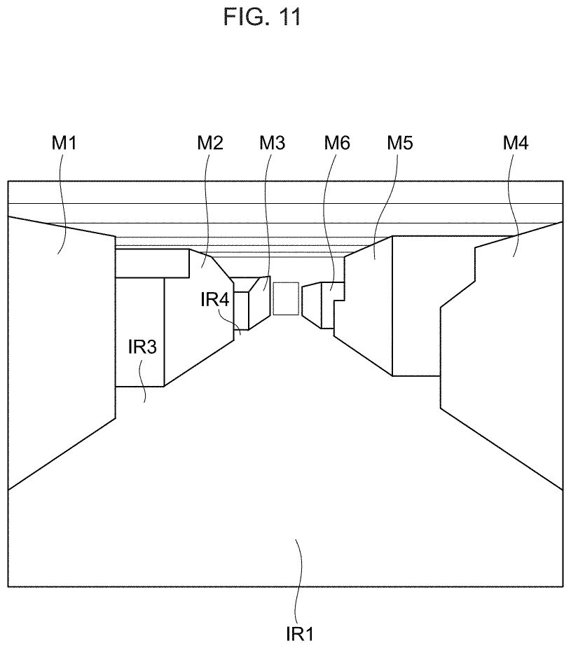

The component transporter vehicle 20 and the walking robot 40 (hereafter also referred to as the “moving bodies 20, 40”) move along the indoor movement routes IR and the outdoor movement routes OR. When the moving bodies 20, 40 move along the outdoor movement routes OR, the navigation device 22 and the robot control device 42 find the current positions of the moving bodies 20, 40 using the GPS device 26 and the GPS device 44. When the moving bodies 20, 40 move along the indoor movement routes IR, the navigation device 22 and the robot control device 42 ascertain their current positions based on the results of the image matching performed by the position finding device 82 of the control center 80. Namely, the navigation device 22 and the robot control device 42 are configured so as to switch the type of control used to find their current positions between movement along the outdoor movement routes OR and movement along the indoor movement routes IR. FIG. 11 illustrates an example of a current position image captured from the moving body 20 or 40. The current position image is an image captured when facing toward the east from the position allocated the number N1 out of the numbers N1 to N24 in FIG. 10. In FIG. 11, M1 to M6 are for example machines installed in the blocks B1 to B6 inside the building 100.

Control Flow

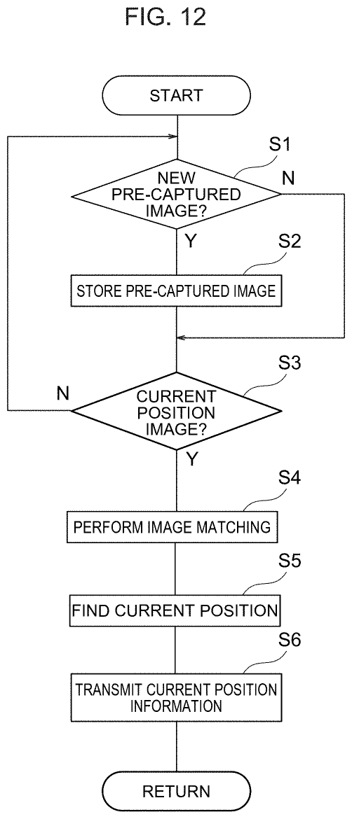

Explanation follows regarding a flow of control processing executed by the position finding device 82, with reference to FIG. 12. The control processing is performed in a state in which the multiple pre-captured images have been stored in the storage 82D of the position finding device 82. In the control processing, first, at step S1 in FIG. 12, the CPU 82A of the position finding device 82 determines whether or not new pre-captured image data has been transmitted from the pre-imaging device 62 of the pre-imaging vehicle 60. In cases in which determination is affirmative, processing transitions to step S2. In cases in which determination is negative, processing transitions to step S3.

In cases in which processing has transitioned to step S2, the CPU 82A uses the functionality of the storage section 86 to store the newly transmitted pre-captured image data in the storage 82D. When the processing of this step is complete, processing transitions to the next step S3.

At step S3, the CPU 82A determines whether or not current position image data has been transmitted from the navigation device 22 of the component transporter vehicle 20 or from the robot control device 42 of the walking robot 40. In cases in which determination is affirmative, processing transitions to step S4. In cases in which determination is negative, processing returns to step S1 described above.

In cases in which processing has transitioned to step S4, the CPU 82A uses the functionality of the matching section 88 to perform image matching between the current position image and the multiple pre-captured images stored in the storage section 86. The CPU 82A thereby searches for a single pre-captured image that is a match for the current position image. When the processing of step S4 is complete, processing transitions to the next step S5.

At step S5, the CPU 82A uses the functionality of the position finding section 90 to find the current position of the component transporter vehicle 20 or the walking robot 40 based on the identifier allocated to the single pre-captured image identified by the matching section 88. When the processing of step S5 is complete, processing transitions to the next step S6.

At step S6, the CPU 82A uses the functionality of the communication section 84 to transmit information regarding the current position found at step S5 to the navigation device 22 or the robot control device 42. When the processing of step S6 is complete, the present routine is ended.

### Summary of Present Exemplary Embodiment

In the position finding system 10 according to the present exemplary embodiment, the multiple pre-captured images, these being respective images of multiple locations, are captured at the multiple locations on the indoor movement routes IR provided inside the building 100. The multiple pre-captured images are associated with respective position information regarding the multiple locations, and stored in the storage 82D of the position finding device 82 provided at the control center 80. When the component transporter vehicle 20 and the walking robot 40 move along the indoor movement routes IR inside the building 100, the navigation device 22 of the component transporter vehicle 20 and the robot control device 42 of the walking robot 40 capture current position images, these being images of the current positions of the component transporter vehicle 20 and the walking robot 40. Data of the captured current position images is transmitted to the position finding device 82 of the control center 80. The position finding device 82 performs image matching between each current position image and the multiple pre-captured images stored in the storage 82D, and finds the current position of the corresponding moving body based on the result of this image matching. This position finding system 10 obviates the need to provide guide markings on the floor, and is therefore capable of a wider range of application than configurations in which a current position is found (ascertained) using such guide markings.

Moreover, in cases in which such guide markings are employed, the guide markings may become difficult to recognize due to wear, or the guide markings may become difficult to recognize due to changes in layout, for example due to packages are placed in the vicinity of the guide markings. For example, the interior layout of a factory building may change on a daily basis due to components and the like being placed in the vicinity of the guide markings. A system configured to find a current position based on guide markings might be unable to accommodate such changes, and so the accuracy of position finding might be affected. In the present exemplary embodiment, due to performing image matching between current position images captured from the moving bodies 20, 40 and the multiple pre-captured images captured at the multiple locations on the indoor movement routes IR, any issues relating to a reduction in the precision of image matching as a result of layout changes in the vicinity of guide markings can accordingly be suppressed. The accuracy of position finding can accordingly be enhanced.

Moreover, in the present exemplary embodiment, when the component transporter vehicle 20 and the walking robot 40 move along the indoor movement routes IR inside the building 100, the current positions of the component transporter vehicle 20 and the walking robot 40 are found based on the results of the image matching described previously. On the other hand, when the component transporter vehicle 20 and the walking robot 40 move along the outdoor movement routes OR outside the building 100, the current positions of the component transporter vehicle 20 and the walking robot 40 are found using the GPS devices 26, 44 respectively installed to the component transporter vehicle 20 and the walking robot 40. While inside the building 100 (while indoors), the GPS devices 26, 44 have difficulty receiving signals from GPS satellites. However, since there is less variation in the appearance of the surroundings as a result of the weather or the time of day, precise image matching is more easily secured. It is therefore preferable to switch the method employed to find the current position in the manner described above.

Note that there are various methods, including Colorbit technology or magnetic markers, that may be applied as a position finding method. However, it is not always feasible to install such equipment in for example factories where the layout changes on a daily basis. In the present exemplary embodiment, in the case of the component transporter vehicle 20 for example, it is sufficient to install the vehicle exterior camera 28 in addition to the navigation device 22, and so the equipment requirements are simpler than those when employing Colorbit technology or magnetic markers. In cases in which the layout changes on a daily basis, it is sufficient that the multiple pre-captured images stored in the storage 82D of the position finding device 82 be updated (for example overwritten) during an update of the pre-imaging step performed by the pre-imaging vehicle 60, thereby enabling such changes to be flexibly and simply accommodated.

Moreover, in the present exemplary embodiment, when the walking robot 40 moves along the indoor movement routes IR, the current position of the walking robot 40 is found based on the results of the image matching described previously. Since the walking robot 40 moves at a lower speed than a typical vehicle, there is ample time in which to perform the image matching processing.

Moreover, in the present exemplary embodiment, the storage section 86 of the position finding device 82 stores the respective position information regarding the multiple locations on the indoor movement routes IR in the storage 82D in association with the multiple pre-captured images using the identifiers (such as numbers, symbols, or names) that are respectively allocated to the multiple locations. Employing such identifiers facilitates association of the multiple pre-captured images with the respective position information.

### Supplementary Explanation of Exemplary Embodiment

Although a case has been described in the above exemplary embodiment in which the pre-imaging step is implemented by the pre-imaging device 62 installed to the pre-imaging vehicle 60, there is no limitation thereto. For example, the pre-imaging step may be implemented using a mobile terminal (such as a smartphone or a tablet) that can be carried around by an operator at the factory.

Although a case has been described in the above exemplary embodiment in which the in-motion imaging step is implemented by the navigation device 22 installed to the component transporter vehicle 20, serving as a moving body, there is no limitation thereto. For example, the in-motion imaging step may be implemented using a mobile terminal (such as a smartphone or a tablet) that can be brought on and off the moving body.

Although a configuration has been described in the above exemplary embodiment in which the storage step, the matching step, and the position finding step are implemented by the position finding device 82 provided to the control center 80, there is no limitation thereto. For example, the storage step, the matching step, and the position finding step may be implemented by the navigation device 22 installed to the component transporter vehicle 20. In such a case, the multiple pre-captured images are stored in the storage 24D of the navigation device 22, and the navigation device 22 functions as a storage section, an in-motion imaging section, a matching section, and a position finding section. In this context, the disclosure may be considered to relate to the navigation device. In such a case, the multiple pre-captured images may be transmitted directly from the pre-imaging device 62 to the navigation device 22.

Although the component transporter vehicle 20 serving as a moving body is a manually driven vehicle in the above exemplary embodiment, there is no limitation thereto. A moving body may be configured by a vehicle that is capable of autonomous driving.

Note that the respective processing executed by the CPUs 24A, 42A, 64A, 82A reading and executing software (programs) in the above exemplary embodiment may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The respective processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

In the above exemplary embodiment, the programs are in a format pre-stored (installed) in a computer-readable non-transitory recording medium. For example, the program for the position finding device 82 is pre-stored in the storage 82D. However, there is no limitation thereto, and the programs may be provided in a format recorded on a non-transitory recording medium such as compact disc read only memory (CD-ROM), digital versatile disc read only memory (DVD-ROM), or universal serial bus (USB) memory. Alternatively, the respective programs may be provided in a format downloadable from an external device through a network.

Although the multiple pre-captured images are stored in the storage 82D in the above exemplary embodiment, there is no limitation thereto. The multiple pre-captured images may be recorded on a non-transitory recording medium such as one of those mentioned above.

The flow of control processing described in the above exemplary embodiment is merely an example, and unnecessary steps may be omitted, new steps may be added, and the processing sequence may be changed within a range not departing from the spirit of the present disclosure.

What is claimed is:

1. A position finding method comprising:
capturing respective images of multiple locations on a movement route of a moving body at the multiple locations;
associating the respective images of the multiple locations with respective position information relating to the multiple locations;
storing the respective images on a storage medium in association with the respective position information;
capturing an image of a current position of the moving body from the moving body while the moving body is moving along the movement route;
performing image matching between the current position image and the respective images stored on the storage medium to identify a single image that is a match for the current position image from among the respective images; and
finding the current position of the moving body based on position information associated with the single image.

2. The position finding method of claim 1, wherein:
the movement route is an indoor movement route provided indoors;
the indoor movement route is connected to an outdoor movement route provided outdoors; and
while the moving body is moving along the outdoor movement route, the current position of the moving body is found using a GPS device installed to the moving body.

3. The position finding method of claim 1, wherein the moving body is a walking robot.

4. The position finding method of claim 1, wherein:
identifiers are respectively allocated to the multiple locations; and
the respective images are stored on the storage medium so as to be associated with the respective position information using the respective identifiers.

5. The position finding method of claim 1, wherein an image of the current position is captured at fixed time intervals while the moving body is moving along the movement route.

6. The position finding method of claim 1, wherein capturing of the respective images of the multiple locations is performed using a pre-imaging vehicle installed with a vehicle exterior camera.

7. A position finding system comprising:
a storage section configured to store, on a storage medium, respective images of multiple locations on a movement route of a moving body and captured at the multiple locations such that the respective images are in association with respective position information relating to the multiple locations;
an in-motion imaging section installed to the moving body and configured to capture an image of a current position of the moving body while the moving body is moving along the movement route;
a matching section configured to perform image matching between the current position image and the respective images stored on the storage medium to identify a single image that is a match for the current position image from among the respective images; and
a position finding section configured to find the current position of the moving body from position information associated with the single image.

8. The position finding system of claim 7, wherein:
the movement route is an indoor movement route provided indoors;
the indoor movement route is connected to an outdoor movement route provided outdoors; and
while the moving body is moving along the outdoor movement route, the current position of the moving body is found using a GPS device installed to the moving body.

9. The position finding system of claim 7, wherein the moving body is a walking robot.

10. The position finding system of claim 7, wherein the storage section is configured to store the respective images on the storage medium so as to be associated with the respective position information using identifiers respectively allocated to the multiple locations.

11. The position finding system of claim 7, wherein the in-motion imaging section is configured to capture an image of the current position at fixed time intervals while the moving body is moving along the movement route.

12. The position finding system of claim 7, wherein the respective images of the multiple locations are captured using a pre-imaging vehicle installed with a vehicle exterior camera.
